(19) United States
(12) Patent Application Publication
(10) Pub. No.: US 2022/0193854 A1
(43) Pub. Date: Jun. 23, 2022

(54) Arm Unit for a Lawn Mower Blade Sharpening and Task Robot

(71) Applicant: Brian F. Smith, Monkton, MD (US)

(72) Inventor: Brian F. Smith, Monkton, MD (US)

(21) Appl. No.: 17/555,639

(22) Filed: Dec. 20, 2021

Related U.S. Application Data
(60) Provisional application No. 63/128,045, filed on Dec. 19, 2020.

(51) Int. Cl. B24B 3/36; B24B 47/22

(52) U.S. Cl. CPC B24B 3/365; B24B 47/22

(57) ABSTRACT

An arm unit for a lawn mower blade sharpening and task robot that raises and lowers a plate and/or docking unit, and/or sharpening unit, and/or task unit to complete instructions of sharpening and/or docking and/or tasks on a lawn mower blade, and/or lawn mower blade spindle, and/or lawn mower deck assembly.

### CROSS REFERENCE TO RELATED APPLICATIONS

This application claims the benefit of U.S. Provisional Application No. 63/128,045, filed Dec. 19, 2020, the disclosure of which is incorporated herein by reference in its entirety.

### BACKGROUND OF THE INVENTION

### Field of the Invention

The present disclosure relates to lawn mower blade sharpening and task robots and, more specifically, to an arm unit incorporated into a lawn mower blade sharpening and task robot.

### Description of Related Art

Blade sharpening and task robots have been developed for the purposes of sharpening and/or otherwise servicing lawn mower blades and related features below lawn mower decks while the blade(s) are still attached to the lawn mower. Examples of such robots are disclosed in U.S. Application Publication No. 2021/0007281, which is incorporated herein by reference in its entirety.

In order to perform a task of any kind under a lawn mower with the lawn mower deck and/or lawn mower blade still attached to the lawn mower, there are height and clearance challenges to get to these parts, which are very typically further off of the ground than the lawn mower deck clearance.

Given these previous challenges listed, it is very important to make sure a sharpening robot is able to accommodate these clearances and height challenges when achieving its sharpening and task goals as these clearances and heights vary.

Having the ability for a sharpening and/or task robot to clear under a lawn mower deck and then have the ability to reach upward to accommodate and achieve sharpening and/or tasks to the lawn mower, lawn mower deck assembly and/or lawn mower spindle is critical to the care of these elements.

Therefore, a need exists in the field for an autonomous and/or manual arm unit incorporated into a sharpening and task robot that has the ability to expand in order to reach lawn mower blades that are still attached to the mower for purposes of sharpening and or other tasks as well as have the ability to expand in order to reach a lawn mower deck assembly and/or the lawn mower spindle for task operations.

### SUMMARY OF THE INVENTION

In accordance with an aspect of the present disclosure, an arm unit for a lawn mower blade sharpening and task robot is disclosed. The arm unit may include at least one motor, at least one drive mechanism, and at least one raising/lowering arm mechanism, wherein the at least one raising/lowering arm mechanism is configured to move relative to the lawn mower blade sharpening and task robot via the at least one drive mechanism. Additionally, the arm unit may include at least one sensor, and at least one power source.

In some embodiments, the arm unit may also include a processing device capable of executing programming instructions to control operation of the arm unit.

In some embodiments, the arm unit may also include at least one plate coupled to an end of the at least one raising/lowering arm mechanism.

In some embodiments, the at least one plate is configured for coupling to at least one unit configured to perform at least one of servicing and sharpening for at least one of one or more lawn mower blades, one or more lawn mower deck assemblies, and one or more lawn mower spindles.

In some embodiments, the at least one drive mechanism may include one or more of a worm gear device, a multi-gear device, a direct drive device, a cable device, a fluid device, a pneumatic device, and a pulley system device.

In some embodiments, the at least one raising/lowering arm mechanism may include a nesting/conical arm.

In some embodiments, the at least one raising/lowering arm mechanism may include a threaded arm.

In some embodiments, the at least one raising/lowering arm mechanism may include an inflatable arm.

In some embodiments, the at least one raising/lowering arm mechanism may include a scissor arm.

In some embodiment, the at least one raising/lowering arm mechanism may include a multi-translational arm.

In some embodiments, the at least one raising/lowering arm mechanism may include a single arm.

According to another aspect of the present disclosure, an autonomous lawn mower blade sharpening and task robot configured to drive under at least one of a lawn mower and a lawn mower deck is disclosed. The robot may include an arm unit, the arm unit having at least one motor, at least one drive mechanism, and at least one raising/lowering arm mechanism, wherein the at least one raising/lowering arm mechanism is configured to move relative to the autonomous lawn mower blade sharpening and task robot via the at least one drive mechanism. The arm unit may also include at least one sensor and at least one power source.

In some embodiments, the arm unit further includes at least one plate coupled to an end of the at least one raising/lowering arm mechanism.

In some embodiments, the at least one plate is configured for coupling to at least one unit configured to perform at least one of servicing and sharpening for at least one of one or more lawn mower blades, one or more lawn mower deck assemblies, and one or more lawn mower spindles.

In some embodiments, the at least one drive mechanism may include one or more of a worm gear device, a multi-gear device, a direct drive device, a cable device, a fluid device, a pneumatic device, and a pulley system device.

In some embodiments, the at least one raising/lowering arm mechanism may include at least one of a nesting/conical arm, a threaded arm, an inflatable arm, a scissor arm, a multi-translational arm, and a single arm.

In some embodiments, the robot may include a processing device capable of executing programming instructions to control operation of the arm unit.

The mechanism(s) by which the arm unit operates in some embodiments may be by means of software executed by a processor or processing device, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices.

The arm unit in some embodiments may be used to deliver a docking unit and/or a sharpening unit and/or a task unit to a lawn mower blade and/or lawn mower deck assembly and/or lawn mower spindle.

The present invention comprises a unit consisting of software, and/or hardware, and/or manual operations, and/or piloted operations, and/or remote operations, and/or autonomous operations, and/or one or more motors, and/or one or more computing device, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices.

Through a series of one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices, the arm unit has the ability to raise, lower, articulate, turn twist, and/or otherwise position a docking unit and/or task unit, in any position relating to a lawn mower blade(s) and/or any part and/or position of a lawn mower deck assembly, and/or spindle(s).

### BRIEF DESCRIPTION OF THE DRAWING(S)

Some embodiments of the present invention are depicted as illustration examples and are not limited to or by the figures or letters accompanying the drawings, and similar references may be indicative of similar components, and/or elements and in which:

FIG. 1A illustrates an example of worm gear device in accordance with an aspect of the present disclosure;

FIG. 1B illustrates an example of a multi-gear device in accordance with an aspect of the present disclosure;

FIG. 1C illustrates an example of direct drive device in accordance with an aspect of the present disclosure;

FIG. 1D illustrates an example of a cable device in accordance with an aspect of the present disclosure;

FIG. 1E illustrates an example of fluid and/or pneumatic device In accordance with an aspect of the present disclosure;

FIG. 1F illustrates an example of a pulley system device in accordance with an aspect of the present disclosure;

FIG. 2A illustrates an example of a nesting/conical arm in accordance with an aspect of the present disclosure;

FIG. 2B illustrates an example of threaded arm in accordance with an aspect of the present disclosure;

FIG. 2C illustrates an example of an inflatable arm in accordance with an aspect of the present disclosure;

FIG. 2D illustrates an example of a scissor arm in accordance with an aspect of the present disclosure;

FIG. 2E illustrates an example of multi-translational arm in accordance with an aspect of the present disclosure;

FIG. 2F illustrates an example of a single arm in accordance with an aspect of the present disclosure;

FIG. 3A illustrates an arm unit in a lowered position in accordance with an aspect of the present disclosure;

FIG. 3B illustrates the arm unit of FIG. 3A in a raised position in accordance with an aspect of the present disclosure;

FIG. 4A illustrates an example of a lowered and/or collapsed arm unit incorporated, in any form, into a lawn mower blade sharpening and task robot in accordance with an aspect of the present disclosure; and

FIG. 4B illustrates an example of a raised and/or expanded arm unit incorporated, in any form, into a lawn mower blade sharpening and task robot in accordance with an aspect of the present disclosure.

### DESCRIPTION OF THE INVENTION

This disclosure is not limited to the particular devices, systems, methodologies, or protocols described and/or shown in the drawings, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used in this document have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used in this document, the term “comprising” means “including, but not limited to.”

The terms “computing device” and “electronic device” interchangeably refer to a device having a processor and a non-transitory, computer-readable medium (i.e., memory). The memory may contain programming instructions in the form of a software application that, when executed by the processor, causes the device to perform one or more processing operations according to the programming instructions. An electronic device also may include additional components such as a touch-sensitive display device that serves as a user interface, as well as one or more cameras for capturing images, one or more sensors, etc. An electronic device also may include one or more communication hardware components such as a transmitter and/or receiver that will enable the device to send and/or receive signals to and/or from other devices, whether via a communications network or via near-field or short-range communication protocols. If so, the programming instructions may be stored on the remote device and executed on the processor of the computing device as in a thin client or Internet of Things (IoT) arrangement.

The terms “memory”, “memory device”, and/or “computer-readable medium” each refer to a non-transitory device on which computer-readable data, programming instructions in the form of a software application, or both are stored. Unless the context specifically states that a single device is required or that multiple devices are required, the terms “memory”, “memory device”, and “computer-readable medium” include both the singular and plural embodiments, as well as portions of such devices such as memory sectors.

A “processor” or “processing device” is a hardware component of an electronic device that is configured to execute programming instructions. The term “processor” may refer to either a single processor or to multiple processors that together implement various steps of a process. Unless the context specifically states that a single processor is required or that multiple processors are required, the term “processor” includes both the singular and plural embodiments.

The present disclosure relates to an arm unit incorporated into a lawn mower blade sharpening and task robot. More specifically, the present disclosure relates to a novel manner in which, through either a manual and/or autonomous means, an arm unit delivers a docking unit and/or task unit, such as a sharpening unit, to a lawn mower blade and/or lawn mower deck assembly and/or lawn mower spindle for the purposes of sharpening or other needed tasks of a lawn mower blade, and/or lawn mower deck assembly and/or lawn mower spindle. In some embodiments, the arm unit may be incorporated into a lawn mower blade sharpening and task robot. The mechanism(s) by which the arm unit operates in some embodiments may be by means of software executed by a processor or processing device, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices.

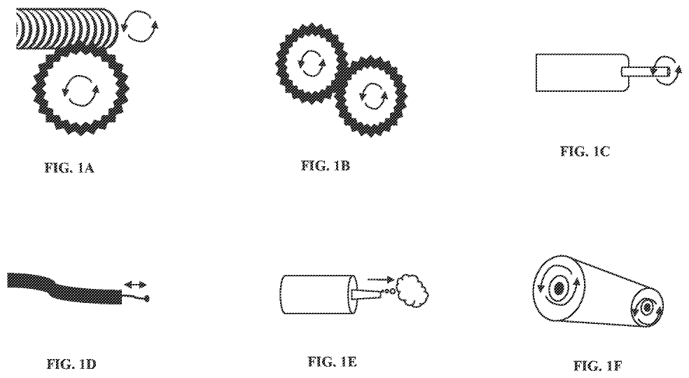

FIGS. 1A-1F, 2A-2F, 3A-3B, and 4A-4B illustrate embodiments of an arm unit(s) that may be incorporated into a lawn mower blade sharpening robot that contains a system comprising one or more gear and/or drive mechanism(s), one or more arms, one or more motors, one or more plates, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices.

Specifically, one or more of the devices shown in FIGS. 1A-1F may be utilized with and/or incorporated into a lawn mower blade sharpening robot in accordance with the present disclosure. FIG. 1A depicts an example of a worm gear device, FIG. 1B depicts an example of a multi-gear device, FIG. 1C depicts an example of a direct drive device, FIG. 1D depicts an example of a cable device, FIG. 1E depicts an example of a fluid and/or pneumatic device, and FIG. 1F depicts an example of a pulley system device.

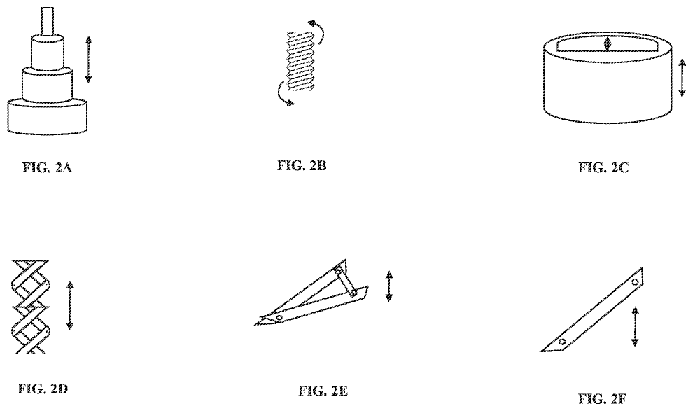

FIG. 2A depicts an example of a nesting/conical arm in accordance with an aspect of the present disclosure. In some embodiments, this arm would have the ability to expand up and down through nesting.

FIG. 2B depicts an example of threaded arm in accordance with another aspect of the present disclosure. In some embodiments, the threaded arm would have the ability to raise and lower by means of a thread through a turning motion.

FIG. 2C illustrates an example of an inflatable arm in accordance with another aspect of the present disclosure. Through pneumatics, fluid, or other bladder capabilities, the arm shown in FIG. 2C has the ability to raise and lower upon inflation and deflation.

FIG. 2D depicts an example of a scissor arm in accordance with another aspect of the present disclosure. In some embodiments, this scissor arm has the ability to raise and lower through a series of smaller arms that translate on a vertical line in order to collapse and expand.

FIG. 2E illustrates an example of multi-translational arm in accordance with another aspect of the present disclosure. In some embodiments, this multi-translational arm may have several arms similar to its own that are attached and act in concert to translate on a vertical line in order to collapse and expand.

FIG. 2F illustrates an example of a single arm in accordance with another aspect of the present disclosure.

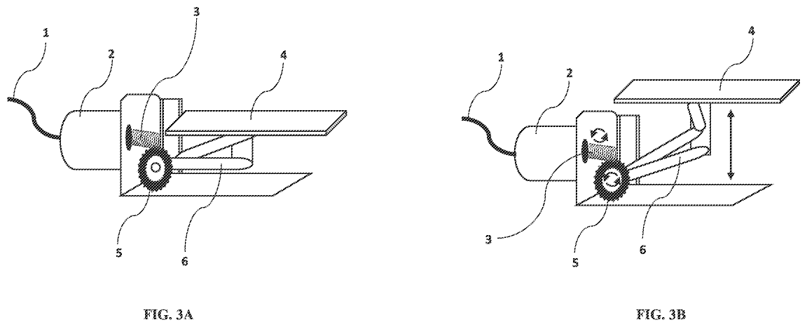

Referring now to FIG. 3A, an example of an arm unit in a lower position in accordance with an aspect of the present disclosure is illustrated. The arm unit in FIG. 3A depicts a power cord 1, a motor 2, and a drive mechanism 3 (in this case, in the form of a worm gear drive, although it is to be understood that any appropriate drive mechanism may be utilized). The arm unit also includes a plate 4 for fixation and/or positioning of a docking unit and/or task unit and/or other units for which would service and/or complete sharpening and/or complete tasks for lawn mower blade(s) and/or lawn mower deck assembly (or assemblies) and/or lawn mower spindle. The arm unit may further include a single gear 5 interfaced with a worm gear drive (i.e., drive mechanism 3) to control the raising and lowering of the arm(s) 6. The arm 6 is shown in a lowered and/or collapsed position in FIG. 3A.

Referring to FIG. 3B, an example of the arm unit in a raised position is illustrated. That is, the arm(s) 6 of the arm unit are in a raised and/or expanded position, thereby raising the plate 4 to a desired height. It is to be understood that the distance which the arms(s) 6 and/or plate 4 may be raised can be any appropriate height.

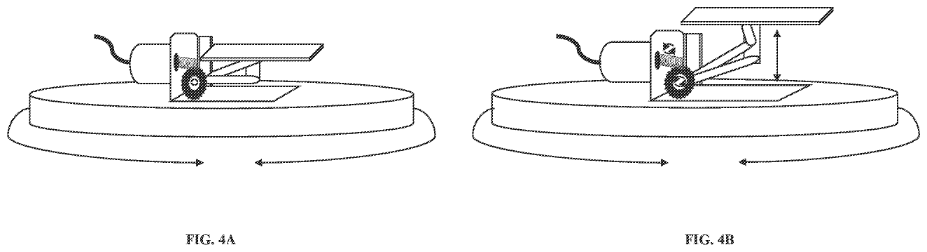

Next, referring to FIG. 4A, an example of a lowered and/or collapsed arm unit (such as that described above with respect to FIG. 3A) incorporated, in any form, into a lawn mower blade sharpening and task robot in accordance with an aspect of the present disclosure is shown. In some embodiments, the lawn mower blade sharpening and task robot may be one or more of the robots disclosed in U.S. Application Publication No. 2021/0007281, which is incorporated herein by reference in its entirety.

FIG. 4B illustrates an example of a raised and/or expanded arm unit (such as that described above with respect to FIG. 3B) incorporated, in any form, into a lawn mower blade sharpening and task robot in accordance with an aspect of the present disclosure.

Once activated, the arm unit shown and described with respect to FIGS. 3A-4B will raise and lower in order to achieve the sharpening and/or task it is instructed to complete. The arm unit may be raised and/or lowered and/or collapsed and/or expanded at any height(s) and/or levels.

An example of the steps of operating the arm unit in accordance with an embodiment of the present disclosure may be as follows: First, by means of software, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices, the arm unit raises to deliver a docking unit, and/or task unit, on a plate, in order to complete sharpening(s) and/or task(s) that the arm unit is instructed to do. Next, once sharpening(s) and/or task(s) are completed, by means of software, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices, the arm unit lowers after delivering a docking unit, and/or task unit, on a plate, in order to complete sharpening(s) and/or task(s) the arm unit is instructed to do.

As detailed above with respect to FIGS. 3A-4B, the present application discloses an arm unit for a lawn mower blade sharpening and task robot in which to raise and/or lower a plate and/or a docking unit and/or a sharpening unit and/or task unit to complete sharpenings and/or tasks on a lawn mower blade(s), and/or lawn mower spindle(s), and/or lawn mower deck assembly (or assemblies).

By means of software executed by a processor or processing device, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices, the arm unit raises to deliver a docking unit, and/or task unit, on a plate, in order to complete sharpening(s) and/or task(s) it is instructed to do.

Once sharpening(s) and/or task(s) are completed, by means of software executed by a processor or processing device, and/or hardware, and/or manually, and/or piloted, and/or remotely, and/or autonomously, and/or one or more motors, and/or one or more computing devices, and/or one or more servos, and/or one or more sensors, and/or one or more lasers, and/or one or more cameras, and/or one or more triggers, and/or one or more pulses, and/or one or more gears, and/or one or more direct drives, and/or one or more offset drives, and/or one or more belts, and/or one or more pulleys, and/or one or more lift devices, and/or one or more fluid devices, and/or one or more pneumatic devices, and/or one or more cable devices, and/or one or more cam device, and/or one or more spring devices, and/or one or more threaded devices, and/or one or more translational expanding/contracting devices, and/or one or more vertical expanding/contracting devices, and/or one or more horizontal expanding/contracting devices, the arm unit lowers after delivering a docking unit, and/or task unit, on a plate, in order to complete sharpening(s) and/or task(s) it is instructed to do.

It is understood that many variations, changes, and modifications may be made and effected in the present invention although it has been detailed and specific in its embodiments and descriptions.

The invention claimed is:

1. An arm unit for a lawn mower blade sharpening and task robot, comprising:
a. at least one motor;
b. at least one drive mechanism;
c. at least one raising/lowering arm mechanism, wherein the at least one raising/lowering arm mechanism is configured to move relative to the lawn mower blade sharpening and task robot via the at least one drive mechanism;
d. at least one sensor; and
e. at least one power source.

2. The arm unit of claim 1, further comprising a processing device capable of executing programming instructions to control operation of the arm unit.

3. The arm unit of claim 1, further comprising at least one plate coupled to an end of the at least one raising/lowering arm mechanism.

4. The arm unit of claim 3, wherein the at least one plate is configured for coupling to at least one unit configured to perform at least one of servicing and sharpening for at least one of one or more lawn mower blades, one or more lawn mower deck assemblies, and one or more lawn mower spindles.

5. The arm unit of claim 1, wherein the at least one drive mechanism comprises one or more of a worm gear device, a multi-gear device, a direct drive device, a cable device, a fluid device, a pneumatic device, and a pulley system device.

6. The arm unit of claim 1, wherein the at least one raising/lowering arm mechanism comprises a nesting/conical arm.

7. The arm unit of claim 1, wherein the at least one raising/lowering arm mechanism comprises a threaded arm.

8. The arm unit of claim 1, wherein the at least one raising/lowering arm mechanism comprises an inflatable arm.

9. The arm unit of claim 1, wherein the at least one raising/lowering arm mechanism comprises a scissor arm.

10. The arm unit of claim 1, wherein the at least one raising/lowering arm mechanism comprises a multi-translational arm.

11. The arm unit of claim 1, wherein the at least one raising/lowering arm mechanism comprises a single arm.

12. An autonomous lawn mower blade sharpening and task robot configured to drive under at least one of a lawn mower and a lawn mower deck, the robot comprising:
an arm unit, the arm unit comprising:
a. at least one motor;
b. at least one drive mechanism;
c. at least one raising/lowering arm mechanism, wherein the at least one raising/lowering arm mechanism is configured to move relative to the autonomous lawn mower blade sharpening and task robot via the at least one drive mechanism;
d. at least one sensor; and
e. at least one power source.

13. The robot of claim 12, wherein the arm unit further comprises at least one plate coupled to an end of the at least one raising/lowering arm mechanism.

14. The robot of claim 13, wherein the at least one plate is configured for coupling to at least one unit configured to perform at least one of servicing and sharpening for at least one of one or more lawn mower blades, one or more lawn mower deck assemblies, and one or more lawn mower spindles.

15. The robot of claim 12, wherein the at least one drive mechanism comprises one or more of a worm gear device, a multi-gear device, a direct drive device, a cable device, a fluid device, a pneumatic device, and a pulley system device.

16. The robot of claim 12, wherein the at least one raising/lowering arm mechanism comprises at least one of a nesting/conical arm, a threaded arm, an inflatable arm, a scissor arm, a multi-translational arm, and a single arm.

17. The robot of claim 12, further comprising a processing device capable of executing programming instructions to control operation of the arm unit.
